(19) United States
(12) Patent Application Publication
(10) Pub. No.: US 2004/0205479 A1
(43) Pub. Date: Oct. 14, 2004

(54) System and method for creating a multimedia presentation

(76) Inventors: Mark D. Seaman, Greeley, CO (US); Gregory A. Brake, Fort Collins, CO (US); Robert D. Thompson, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/002,356

(22) Filed: Oct. 30, 2001

(51) Int. Cl. G09G 5/12

(52) U.S. Cl. 715/500.1; 715/530

(57) ABSTRACT

A system and method for creating a multimedia presentation are disclosed. Briefly described, one embodiment, among others, can be implemented as a computer-readable medium having a program for composing a multimedia presentation from a plurality of media elements having audio media elements and image elements. The image elements comprise at least one still image. The program comprises logic configured to: determine at least one control setting, the control setting including the duration time for display of the at least one still image in an initial presentation; and automatically compose the initial presentation, the initial presentation including the plurality of media elements, the initial presentation based in part on the duration time for the at least one still image and the initial presentation based in part on at least one time stamp associated with at least one of the media elements.

### BACKGROUND OF THE INVENTION

1. Field of the Invention

The present invention generally relates to processing of media elements and, in particular, to a system and method for creating a multimedia presentation.

2. Related Art

Recordings in digital format have become commonplace with the advent of consumer digital recording devices. The recordings may be processed using computer systems that execute logic configured to manipulate the digital data corresponding to the recordings. Examples of the recordings include compact discs (CDs), digital still “photographs,” and digital video discs (DVDs). One example of a digital recording device is a digital based image recording device (e.g., a digital “camera”) capable of “photographing” an image and providing the image in a digital data format, such as the digital still photograph. The computer systems for manipulating the digital data include readily available commercial processors, such as the well-known personal computer (PC), or proprietary processing systems specially dedicated to the processing of the digital data.

For example, an individual may capture digital still images of a special event, such as a wedding, using a commercially-available digital camera. The captured still images may be stored as digital still photographs in the digital camera. The individual typically would, at a later time, process the still images on a personal computer (PC) using a commercially-available digital image processing program. The individual would download the digital still photographs into the PC memory. The individual then selectively orders the still images, such as in a time sequence or event occurrence sequence. Also, the individual may optionally perform various image processing functions, such as, but not limited to, resizing the still image, adding borders to the image, cropping portions of the image, adding meta-data to the image, etc. After the still images have been downloaded to a storage media, such as the PC memory, and processed if desired, one or more still images may be transmitted to others via e-mail or uploaded onto another storage media, such as a floppy disk.

If, for example, at the wedding, several individuals recorded digital still images, each using their own digital still camera, the individuals could choose to download all of the captured digital still images (or selected still images) into the memory of one PC. Then, the group of digital still images could be processed as a coherent grouping of images to memorialize the wedding. Such a coherent grouping of still images could then be published into a wedding album or e-mailed to others for viewing.

However, processing the aggregation of the many digital still images, particularly when the still images are captured by different individuals at different times using their own digital cameras, is a tedious, time-consuming manual process. The person processing the aggregation of digital still images typically would, at some point in the process of creating the desired coherent grouping of still images, time order the still images and/or order the still images according to a predefined occurrence in the event. For example, the person may manually select all digital still images of the bride walking down the aisle, and then time order each of the selected digital still images. Then, the most desirable still images of the bride walking down the aisle could be selected to best memorialize that portion of the wedding.

Furthermore, digital technologies have advanced such that consumer digital video and digital sound capturing devices are able to capture video and sound information in digital format. For example, a plurality of digital video recording devices are typically used to record digital video images (vid-images) of a special event, such as a football game, using commercially-available video cameras or specially fabricated digital motion picture cameras. It would be desirable to be able to quickly incorporate recordings of digital video elements and digital audio elements with the previously discussed digital still images. However, processing the aggregation of the digital video recordings, digital audio recordings, and digital still image recordings, is a tedious, time-consuming manual process. The process is particularly tedious and time-consuming when the recordings are captured by different individuals at different times using their own recording devices.

Attempting to create a multimedia presentation, such as one including digital still images, digital audio elements and digital video elements, further complicates the processing involved compared to memorializing an event solely with digital still images. Unfortunately, such a process of selecting all of the media elements from a large database, and then ordering the media elements, requires a considerable amount of time and concentration on the part of the person processing the media elements. Furthermore, the process is subject to a great degree of error in that the media elements may not be correctly organized. For example, it is not uncommon for media elements to be jumbled in time when they are meant to be in chronological order. On the other hand, it is not uncommon for a media element to be inadvertently misplaced when attempting to place the media elements in a non-chronological order. Also, some media elements may be inadvertently omitted during the initial selection of media elements memorializing the predefined occurrence when there are a great number of media elements to consider, and/or if the visual or audio queues associating the media elements to the predefined occurrence are not readily discernible to the person.

### SUMMARY OF THE INVENTION

Thus, a heretofore unaddressed need exists in the industry for providing a system and method of enabling a person to quickly and accurately organize and process a database of digital still images. Furthermore, a heretofore unaddressed need exists in the industry for providing a system and method of enabling an individual to quickly and accurately select, organize and edit a database having a number of digital media elements, such as, digital still images, digital audio elements, and digital video elements.

The present invention provides a system and method for creating a multimedia presentation. Briefly described, one embodiment, among others, can be implemented as a computer-readable medium having a program for composing a multimedia presentation from a plurality of media elements having audio media elements and image elements. The image elements comprise at least one still image. The program comprises logic configured to: determine at least one control setting, the control setting including the duration time for display of the at least one still image in an initial presentation; and automatically compose the initial presentation the initial presentation including the plurality of media elements, the initial presentation based in part on the duration time for the at least one still image and the initial presentation based in part on at least one time stamp associated with at least one of the media elements.

The present invention can also be viewed as providing methods for creating a multimedia presentation from a plurality of media elements including audio elements and image elements. The image elements include at least one still image. Briefly described, one such method comprises the steps of: determining at least one control setting, the control setting including the duration time for the at least one still image; and composing an initial presentation; the initial presentation including the plurality of media elements, the initial presentation based in part on the duration time for the at least one still image and in part on the time of recording of the plurality of media elements.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram of a general purpose computer including a presentation creation system according to the teachings of the present invention.

FIG. 2 is a flow chart illustrating the creation of a multimedia presentation using the presentation creation system of FIG. 1.

FIG. 3 is an example of the display of an image from a multimedia presentation and the display of two edit lines of the presentation creation system of FIG. 1.

### DETAILED DESCRIPTION OF THE INVENTION

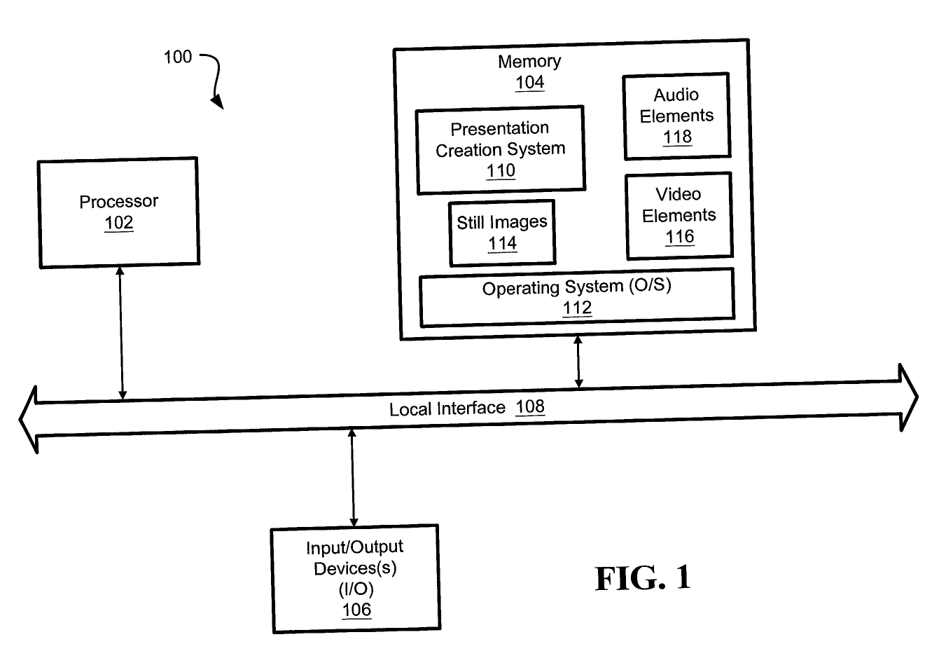

The presentation creation system of the invention can be implemented in software (e.g., firmware), hardware, or a combination thereof. In the currently contemplated best mode, the presentation creation system is implemented in software, as an executable program, and is executed by a special-purpose or general-purpose digital computer, such as a personal computer (IBM-compatible, Apple-compatible, or otherwise), workstation, minicomputer, or mainframe computer. An example of a general-purpose computer that can implement the presentation creation system of the present invention is shown in FIG. 1. In FIG. 1, the presentation creation system is denoted by reference numeral 110.

Generally, in terms of hardware architecture, as shown in FIG. 1, the computer 100 includes a processor 102, memory 104, and one or more input and/or output (I/O) devices 106 (or peripherals) that are communicatively coupled via a local interface 108. The local interface 108 can be, for example but not limited to, one or more buses or other wired or wireless connections, as is known in the art. The local interface 108 may have additional elements, which are omitted for simplicity, such as controllers, buffers (caches), drivers, repeaters, and receivers, to enable communications. Further, the local interface 108 may include address, control, and/or data connections to enable appropriate communications among the aforementioned components.

The processor 102 is a hardware device for executing software that can be stored in memory 104. The processor 102 can be any custom made or commercially-available processor, a central processing unit (CPU), an auxiliary processor among several processors associated with the computer 100, a semiconductor based microprocessor (in the form of a microchip or chip set), a macroprocessor, or generally any device for executing software instructions. A suitable processor 102 is any processor now known or later developed that can support the functionality of the present invention.

The memory 104 can comprise any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 104 may incorporate electronic, magnetic, optical, and/or other types of storage media. Note that the memory 104 can have a distributed architecture, where various components are situated remote from one another, but can be accessed by the processor 102.

The software in memory 104 may comprise one or more separate programs, each of which comprises an ordered listing of executable instructions for implementing logical functions. In the embodiment illustrated in FIG. 1, the software in the memory 104 includes the presentation creation system 110 and a suitable operating system (O/S) 112. The operating system 112 essentially controls the execution of other computer programs, such as the presentation creation system 110, and typically provides scheduling, input-output control, file and data management, memory management, and communication control and related services.

The presentation creation system 110 is a source program, executable program (object code), script, or any other entity comprising a set of instructions to be performed. When a source program, the program needs to be translated via a compiler, assembler, interpreter, or the like, which may or may not be included within the memory 104, so as to operate properly in connection with the O/S 112. Furthermore, the presentation creation system 110 can be written as (a) an object-oriented programming language, which has classes of data and methods, or (b) a procedure-programming language, which has routines, subroutines, and/or functions, for example but not limited to, C, C++, Pascal, Basic, Fortran, Cobol, Perl, Java, and Ada. In the currently contemplated best mode of practicing the invention, the presentation creation system 110 is C++.

The I/O devices 106 may comprise input devices, for example but not limited to, a keyboard, mouse, scanner, microphone, ports for downloading digital data such as digital recordings, etc. Furthermore, the I/O devices 106 may also include output devices, for example but not limited to, a printer, display, etc. Finally, the I/O devices 106 may further include devices that communicate both inputs and outputs, for instance but not limited to, a modulator/demodulator (modem; for accessing another device, system, or network, for example, the Internet), a radio frequency (RF) or other transceiver, a telephonic interface, a bridge, a router, etc.

When the computer 100 is in operation, the processor 102 is configured to execute software stored within the memory 104, to communicate data to and from the memory 104, and to generally control operations of the computer 100 pursuant to the software. The presentation creation system 110 and the O/S 112, in whole or in part, but typically the latter, are read by the processor 102, perhaps buffered within the processor 102, and then executed.

When the presentation creation system 110 is implemented in software, as is shown in FIG. 1, it should be noted that the presentation creation system 110 can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The presentation creation system 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the presentation creation system 110 is implemented in hardware, the presentation creation system can be implemented with any or a combination of the following technologies, which are each well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 104 may also include any one, or a combination, of memory elements storing digital media elements, such as, a memory elements storing digitally recorded still images 114, digital video elements 116, digital audio elements 118, digital tags (not shown) that cue non-digital media elements, and other digital media elements. The digital video elements generally comprise digital audio elements, referred to as “vid-audio” elements, and digital image elements, referred to as “vid-image” elements. A time stamp indicating the time of recording may be associated with the digital media elements.

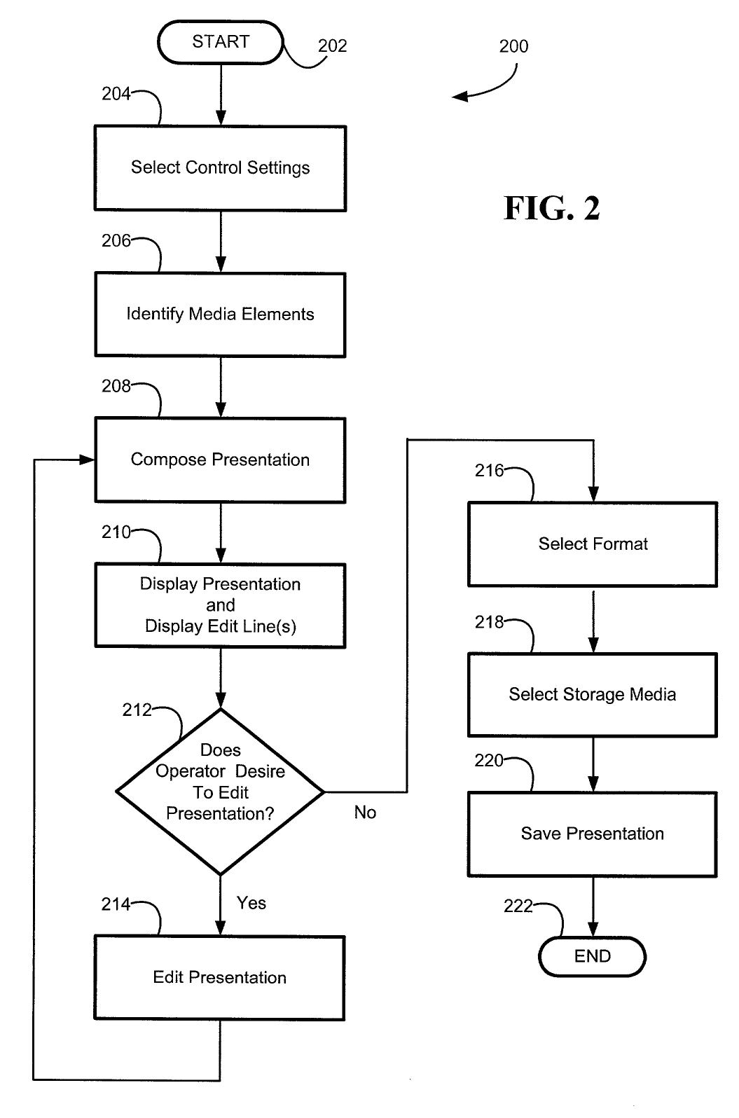

FIG. 2 is a flow chart illustrating the creation of a multimedia presentation. The flow chart 200 of FIG. 2 shows the architecture, functionality, and/or operation of a possible implementation of the software for implementing the presentation creation system 110 of FIG. 1. In this regard, each block may represent a module, segment, or portion of code, which comprises one or more executable instructions for implementing the specific logical function(s). It should also be noted that in some alternative implementations, the functions noted in the blocks may occur out of the order noted in FIG. 2 or may include additional functions without departing significantly from the functionality of the presentation creation system 110 (FIG. 1). For example, two blocks shown in succession in FIG. 2 may in fact be executed substantially concurrently, the blocks may sometimes be executed in the reverse order, or some of the blocks may not be executed in all instances, depending upon the functionality of the embodiment involved, as will be further clarified below. All such modifications and variations are intended to be included within the scope of the present invention.

The process of practicing the presentation creation system 110 (FIG. 1) starts at block 202. The start may be initiated by a user starting or otherwise activating the presentation creation system 110.

At block 204, the user of the presentation creation system 110 selects control settings and/or changes default control settings. The control settings may comprise visual and sound effects, such as: the duration of the display of digital still images, fades, dissolves, image transitions, image borders, sound volume, theme music, sound muting, sound loops, background colors, and other visual and sound effects known to those of ordinary skill in the art. The presentation creation system 110 may have defaults associated with any, or all, of the control settings. In one embodiment, for example, the default for the duration of the display of digital still images may designate that digital still images shall be displayed for 6 seconds.

At block 206, the media elements to be incorporated in the initial presentation are identified. The media elements may include those stored in memory 104 (FIG. 1) and those available from I/O devices 106 (FIG. 1) such as an Internet link, compact discs drives, video player links, and other I/O devices 106 known to those having ordinary skill in the art. The media elements may be identified from the memory elements storing the digital still images 114, digital video elements 116, digital audio elements 118 (FIG. 1), and other digitally recorded media elements. Digital media elements may also include, without limitation, clip art, graphic symbols, sound effects, text, borders, narratives, digital cues for non-digital media elements, and background styles and/or colors. Sound recording media elements may include MP3 format sound recordings. Media elements may have diverse formats.

The media elements to be incorporated in the initial presentation may be identified in a number of ways, e.g., the presentation creation system I 10 presents the user with a list of all digital media elements in memory 104 and offers the user the option of incorporating the listed digital media elements; the presentation creation system 110 offers the user the option to download digital media elements from a digital recording device; the presentation creation system 110 offers the user the option of searching for digital media elements in a database (such as the Internet) that is external to the computer 100; and additional ways of identifying digital data that are known to those having ordinary skill in the art. One embodiment of the presentation creation system 110 comprises all of the identification features described above, while other embodiments have only one of the identification features described above. Additional embodiments include more than one of the identification features described above.

At block 206, the presentation creation system 110 may also provide the user with the option of binding digital media elements with other digital media elements. For example, but not limited to, audio elements may be bound with still images; audio elements may be bound with vid-image elements; audio elements may be bound with video elements in such a manner that the audio elements replaces all, or a portion, of the vid-audio elements; and a first image element may be bound to a second image element such that the first and second image elements will appear in the presentation at the same time. If there is a time stamp associated with more than one of the digital media elements being bound in block 206, the presentation creation system 110 will preferably offer the user the option of designating which time stamp will be associated with the bound digital media elements.

The user may also have the option of unbinding digital media elements. For example, the digital vid-images and vid-audio elements of digital video elements may be unbound to form a separate audio element and a digital vid-image element, and previously bound digital still images and digital audio elements may be unbound. The presentation creation system 110 may offer the user the option of associating a new time with any unbound digital media elements.

The presentation creation system 110 also creates copies of the time stamps associated with the digital media elements. This enables a user, via the presentation creation system 110, to selectively manipulate the copies of the time stamps for creating the multimedia presentation, while preserving the original time stamp associated with the digital media elements. The term “time stamp” may refer to the original time stamp or a copied time stamp. Block 206 concludes with the user indicating they have completed the identification of digital media elements to be incorporated in the presentation or other similar event marking features.

At block 208, the presentation creation system 110 automatically composes an initial presentation by sorting the identified media elements from block 206 according to the selected control settings from block 204. When block 208 is entered from block 214, the presentation creation system 110 automatically composes an edited presentation. The term “automatically” in this context indicates the ability to create a presentation without further input from the user after the user indicates completion of the media element identification process of block 206 or that they have completed the editing process of block 214.

The initial presentation preferably comprises an image-track and a soundtrack. The image-track is the visual portion of the presentation. The image-track provides the digital image elements in the order of display as determined by the presentation creation system 110. The soundtrack is the audio portion of the presentation. The soundtrack provides the digital audio elements in the order of display as determined by the presentation creation system 110.

The presentation creation system 110 begins composing the image-track by placing any digital still images identified in block 206 in chronological order according to the time stamp, or other designated event-marking feature, associated with the digital still image. In general, digital recording devices include a time stamp, or other designated event marking feature, in the digital data corresponding to the recorded digital media element. A time stamp associated with a digital still image may indicate the time of the recording of the digital still image. The presentation creation system 110 then assigns a display duration (from block 204) to the digital still images. The presentation creation system 110 then chronologically inserts digital vid-images from the digital video elements identified in block 206 into the chronologically ordered still photographs. The insertion of the digital vid-images may be according to time stamps in the digital data corresponding to the recording of the digital video element. If there are image elements, such as digital still images and digital vid-images, that do not have time stamps, the presentation creation system 110 may place the non-stamped image elements at the beginning, or end, of the initial presentation according to a control setting determined in block 204. Alternatively, the presentation creation system 110 may separately group the non-stamped image elements for the user to place in the presentation in a later step, such as the editing of block 214. The presentation creation system 110 completes the composition of the image-track when the images from the media elements identified in block 206 are all placed on the image-track or grouped for insertion in another block of the process.

The presentation creation system 110 begins composing the soundtrack by first placing bound digital audio elements, such as those bound in step 206, in the soundtrack to coordinate with the image elements they are bound to. For example, the presentation creation system 110 may place digital audio elements bound to digital still images in the soundtrack to coordinate with the display of the digital still image. As a further example, the presentation creation system 110 may place vid-audio elements of a digital video element with the digital vid-images of the digital video element. The presentation creation system 110 may then place unbound audio elements in chronological order according to the time stamps, or other designated event marking feature, associated with the digital data corresponding to the audio elements. Alternatively, the presentation creation system 110 may group the non-stamped audio elements separately for the user to place in the presentation in a later step, such as the editing of block 214. Finally, the presentation creation system 110 may place any unbound and unstamped audio elements at the beginning or end of the soundtrack. The presentation creation system 110 completes the composition of the soundtrack when the identified audio elements have been included in the soundtrack or grouped for insertion in another block of the process.

The presentation creation system 110 automatically composes the edited presentation when block 208 is approached from block 214. The composition of the edited presentation is similar to the composition of the initial presentation except that the edited presentation includes the edits made by the user in block 214.

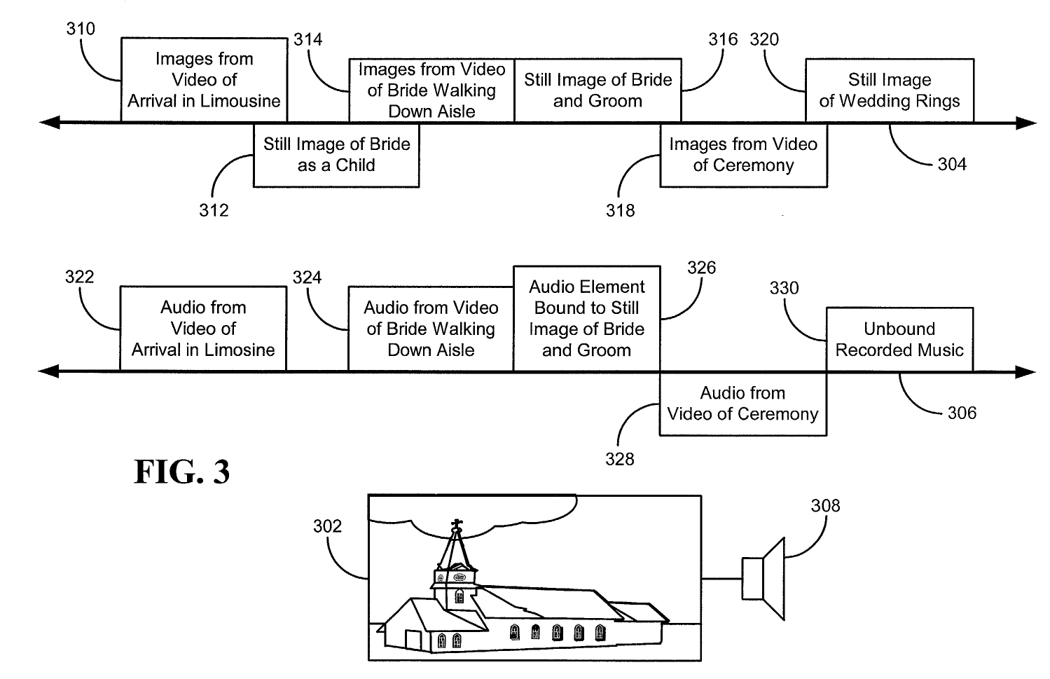

At block 210, the presentation creation system 110 displays the initial presentation and may also display one or more edit lines associated with the initial presentation. FIG. 3 is a non-limiting example of the display of an image 302 from a multimedia presentation and the display of two edit lines of the presentation creation system 110 of FIG. 1. The edit lines shown in FIG. 3 are image line 304 and a sound line 306. The presentation creation system 110 displays the presentation by using one of the many commercially-available multimedia presentation players known to those having ordinary skill in the art, such as, Windows Media Player and Apple Quicktime Player. The commercially-available multimedia presentation players generally include a driver for generating sounds with a speaker 308.

The image line 304 shows graphical representations of the image elements included in the presentation. For example, image line 304 includes: a first image box 310 representing digital vid-images of the digital video element generated by recording the arrival of a wedding party in a limousine; a second image box 312 representing a digital still image of the bride as a child; a third image box 314 representing digital vid-images of the digital video element generated by a recording the bride walking down the aisle; a fourth image box 316 representing a digital still image of the bride and groom; a fifth image box 318 representing digital vid-images of the digital video element generated by recording the ceremony; and, a sixth image box 320 representing a digital still image of the wedding rings.

As shown in FIG. 3, some image boxes, such as first image box 310 and second image box 312, may overlap on the image line 304. Such overlaps may occur if, for example, but not limited to, the image elements were recorded contemporaneously, or if the time stamp associated with the image element has been changed in block 206, or if the time stamp was changed due to an edit in block 214. In these situations, the image elements may have overlapping time stamps associated with the digital data corresponding to the image elements.

The sound line 306 shows graphical representations of the audio elements included in the presentation. For example, sound line 306 includes: a first sound box 322 representing the vid-audio element of the digital video element generated by recording the arrival of the wedding party in a limousine; a second sound box 324 representing the vid-audio element of the digital video element generated by recording the bride walking down the aisle; a third sound box 326 representing a digital audio element bound to the digital still image of the bride and groom (represented by the fourth image box 316); a fourth sound box 328 representing the vid-audio element of the digital video element generated by recording the ceremony; and, a fifth sound box 330 representing an unbound digital audio element of recorded music.

The image line 304 and the sound line 306 may be displayed in coordination with the presentation, such that the graphical representations on the image line 304 and the sound line 306 correspond to the image and sounds being displayed by the multimedia presentation player.

Returning to FIG. 2, at block 212, the presentation creation system 110 accepts input from the user indicating whether the user desires to edit the presentation. If the user desires to edit the presentation (the Yes condition) the process proceeds to block 214. At block 214, the presentation creation system 110 edits the presentation based on user input. Editing may include resetting the control settings of block 204. Editing may also include, but is not limited to, adding or modifying textual annotation, sound annotation, graphic elements, frames, borders, clip art, thought bubbles, and other features known to those having ordinary skill in the art.

Editing may also include, but is not limited to, manipulating the media elements by manipulating the graphical representations of the edit lines, such as image line 304 and sound line 306. For example, the user may grab and drag the graphical representations with a mouse in order to change the order of the media elements in the presentation. The user may select the graphical element and then initiate a copying of the graphical element that may trigger the presentation creation system 110 to create a copy of the media element. The copied media element may then be placed at another location in the presentation.

Editing may also include “popup” screens for the media elements. The display of the popup screen may be triggered by double-clicking on a graphical box representing the media element. The popup screen may include editing features for the media elements, such as, but is not limited to, volume control, contrast, brightness, fade, borders, image enlarging, image shrinking, and other features known to those having ordinary skill in the art.

The user may then indicate the completion of the editing process of block 214. After block 214, the presentation creation system 110 returns to block 208. At block 208, the presentation creation system 110 automatically composes an edited presentation based on the initial presentation and the edits of block 214. The re-composition includes applying any control setting changed in block 214.

If at block 212 the user indicates the user does not wish to edit the presentation (the No condition), the process proceeds to block 216. At block 216, the user selects the format for storage of the presentation. The format may be Motion J-Peg, AVI, QuickTime, or other formats now known or later developed. The user will often select the format based on the multimedia presentation player the user anticipates using to show the presentation to the target audience. The presentation creation system 110 may contain a default format. The default format may be the same as the player used in block 210 to display the presentation.

At block 218, the user selects the media for storage of the presentation. The storage media be a VHS tape that may be accessed via an analog port from computer 100, the PC memory, a disc, or other storage media now known or later developed. The selection may be of a default media selected by the presentation creation system 110.

At block 220, the presentation creation system 110 saves the presentation in the format selected at block 216 and on the storage media selected at block 220. The process ends at block 222.

1. A computer-readable medium having a program for composing a multimedia presentation from a plurality of media elements, the plurality of media elements including audio media elements and image elements, the image elements including at least one still image, the program comprising logic configured to:
determine at least one control setting, the control setting including the duration time for display of the at least one still image in an initial presentation; and
automatically compose the initial presentation, the initial presentation including the plurality of media elements, the initial presentation based in part on the duration time for the at least one still image and the initial presentation based in part on at least one time stamp associated with at least one of the media elements.

2. The program of claim 1, wherein the logic is further configured to display the initial presentation.

3. The program of claim 1, wherein the logic is further configured to display an image line, the image line showing the order of appearance of some of the image elements in the initial presentation.

4. The program of claim 1, wherein the logic is further configured to display a sound line, the sound line showing the order of expression of some of the audio elements in the initial presentation.

5. The program of claim 3, further comprising logic configured for editing the image line.

6. The program of claim 4, further comprising logic for editing the sound line.

7. The program of claim 1, further comprising logic for editing the initial presentation, the logic for editing configured to interface with a user, the logic for editing comprising logic for reordering the media elements.

8. The program of claim 7, further comprising logic for automatically composing an edited presentation based in part on the duration time for the at least one still image.

9. The program of claim 7, further comprising logic for automatically composing an edited presentation based in part on the interfacing with the user.

10. The program of claim 7, wherein the logic for editing further comprises logic for adding graphic elements.

11. The program of claim 7, wherein the logic for editing further comprises logic for adding text elements.

12. The program of claim 7, wherein the logic for editing further comprises logic for resetting control settings.

13. The program of claim 1, wherein the program is configured for operation on a personal computer.

14. A system for composing a multimedia presentation from a plurality of media elements, the plurality of media elements including audio elements, the plurality of media elements including image elements, the image elements including at least one still image, the system comprising:
means for determining at least one control setting, the control setting including the duration time for the at least one still image;
means for automatically composing an initial presentation, the initial presentation including the plurality of media elements, the initial presentation based in part on the duration time for the at least one still image and based in part on the time of recording of the plurality of media elements.

15. The system of claim 14, further comprising a means for displaying the initial presentation.

16. The system of claim 14, further comprising a means for displaying an image line, the image line showing the order of appearance of at least some of the image elements in the initial presentation.

17. The system of claim 14, further comprising a means for displaying a sound line, the sound line showing the order of expression of at least some of the sound elements in the initial presentation.

18. A method for creating a multimedia presentation from a plurality of media elements, the plurality of media elements including audio elements and image elements, the image elements including at least one still image, the method comprising the steps of:
determining at least one control setting, the control setting including the duration time for the at least one still image; and
composing an initial presentation, the initial presentation including the plurality of media elements, the initial presentation based in part on the duration time for the at least one still image and in part on the time of recording of the plurality of media elements.

19. The method of claim 18, further comprising the step of displaying the initial presentation.

20. The method of claim 18, further comprising the step of displaying an image line, the image line showing the order of appearance of at least some of the image elements in the initial presentation.

21. The method of claim 18, further comprising the step of displaying a sound line, the sound line showing the order of expression of at least some of the sound elements in the initial presentation.

22. The system of claim 21, further comprising the step of editing the initial presentation, the step of editing including the step of reordering the media elements.

23. The method of claim 22, further comprising the step of composing an edited presentation, the edited presentation based in part on the duration time for the at least one still image.

24. The method of claim 22, further comprising the step of composing an edited presentation, the edited presentation based in part on the reordered media elements.

25. The method of claim 22, wherein the step of editing further comprises the step of adding graphic elements.

26. The method of claim 22, wherein the step of editing further comprises the step of adding text elements.

27. The method of claim 22, where in the step of editing further comprises the step of resetting control settings.

28. The method of claim 18, wherein the method is performed with a personal computer.
